(19) United States
(12) Patent Application Publication
(10) Pub. No.: US 2010/0275353 A1
(43) Pub. Date: Nov. 4, 2010

(54) INSTALLATION MECHANISM FOR A TOILET COVER MEMBER

(75) Inventor: Binhua Gong, Xiamen (CN)

Correspondence Address: RABIN & Berdo, PC, 1101 14TH STREET, NW, SUITE 500, WASHINGTON, DC, 20005, US

(73) Assignee: BESTTER(XIAMEN) TECHNOLOGY INC., Fujian (CN)

(21) Appl. No.: 12/811,875

(22) PCT Filed: Dec. 16, 2009
(86) PCT No.: PCT/CN09/75612

§ 371 Date: Jul. 7, 2010

(30) Foreign Application Priority Data
Dec. 21, 2008 (CN) 200810072472.2

(51) Int. Cl. A47K 13/00; B23P 17/04

(52) U.S. Cl. 4/234; 29/428

(57) ABSTRACT

An installation mechanism for a toilet cover member comprises a rotating shaft for rotating the cover member, a support base for fixing the rotating shaft and a sleeve for containing the rotating shaft. An elongated hole of the sleeve is provided with at least a first hole in any portion which has bigger aperture than other portions of the elongated hole, the aperture of the first hole matches the peripheral wall of the pin so that the pin can be inserted into the first hole; the middle portion of the pin has a groove, which cooperates with the wall of the sleeve so that when the pin is moved from the first hole, the two sides of the width direction of the elongated hole of the sleeve is clamped in the groove.

### FIELD OF THE INVENTION

The present invention relates to a sanitary ware, more particularly, to an installation mechanism for installing a toilet cover member on a toilet body and which can be assembled and disassembled rapidly.

### BACKGROUND OF THE INVENTION

Toilet is a daily-used sanitary ware in daily life in many places. Usually the toilet comprises a body and a cover member, and the cover member comprises a seat and a cover, the cover member mostly is installed on the body by an installation mechanism, so that the cover member can be rotated relative to the body (i.e. be lift up or put down), in rotation, it can be the seat or the cover rotated only, or both the seat and the cover are rotated. Conventional installation mechanism for the toilet cover member is that the cover member is fixed and pivoted to the body and the cover member can rotated related to the body, i.e. the cover member can be lift up or put down, but the cover member is hard to be disassembled, thus the cover member and the body are hard to be cleaned.

To achieve detachable assembly of the cover member, in prior art, an improved installation mechanism for toilet cover member has been provided, which comprises a button mechanism having a rotating shaft locked to a support base, the button mechanism is mounted to the hole of the rotating shaft to fix the pin, when the cover member is needed to be mounted to the body, it only needs to aim the hole of the rotating shaft which has been installed in a cover member to the pin and then insert it, then the pin will be locked by the button mechanism in the cover member, thus the cover member is fix to the pin, this solution solved the problem of the detachable assembly of the cover member. However, the mechanism has complex structure and high cost, and is inconvenient to be mounted to the cover member. And in disassembly, the user can not release the press for the button mechanism until the end of the pin is been pull out from the hole of the rotating shaft, thus the disassembly of the cover member is inconvenient.

### SUMMARY OF THE INVENTION

The primary object of the present invention is to obviate the disadvantages of the prior art and to provide an installation mechanism with simple structure for the toilet cover member which can be assembled and disassembled conveniently.

The object of the present invention is achieved by providing: an installation mechanism for toilet cover member comprising a rotating shaft for rotating the cover member, a support base for fixing the rotating shaft and a sleeve for containing the rotating shaft; the bottom of the support base is fixed to the body, and the top of the support base is provided with a pin which extended upwardly; the first end of the rotating shaft is provided with an hole along radial direction for inserting the pin of the support base; the sleeve is fixed to or integrated with the end of the cover member, so that the front end of the cover member can be rotated relative to the rotating shaft, the wall of the sleeve is provided with an elongated holed along circumference for inserting and rotating the pin of the support base; the rotating shaft is contained in the sleeve, and the hole of the rotating shaft is aligned to and cooperated with the elongated hole of the sleeve, the pin of the support base is inserted through the elongated hole and cooperated with the hole of the rotating shaft.

The elongated hole of the sleeve is provided with at least a first hole in any portion which has bigger aperture than other portion of the elongated hole, the aperture of the first hole is matching with the peripheral wall of the pin so that the pin can be inserted into the first hole; the middle portion of said pin is provided with a groove, which is cooperated with the wall of the sleeve so that when the pin is moved from the first hole, the two sides of the width direction of the elongated hole of the sleeve is clamped in said groove.

The other object of the present invention is to provide a rapid assembly-disassembly method for the cover member, which comprises:

The rear end of the cover member is provided with a pair of sleeves for containing the rotating shaft, each said sleeve is provided with an elongated hole for inserting and rotating the pin of the support base;

A pair of rotating shafts provided with corresponding hole for connecting to the support base;

A pair of support bases fixed on the body, each support base is provided with a pin which is inserted into the hole of the rotating shaft to connect the support base with the rotating shaft.

The elongated hole of the sleeve is provided with at least a first hole in any portion which has bigger aperture than other portion of the elongated hole, and the middle portion of said pin is provided with a groove, in assembly, the rotating shaft is installed to the cover member, and the hole of the rotating shaft is aimed to the first hole of the elongated hole of the sleeve, then the pin of the support base is insert into the rotating shaft through the first hole, thus the pin is connected to the rotating shaft, and the groove in the middle portion of the pin is positioned in the elongated hole of the sleeve, the pin is moved from the first hole and can not be pull out.

The advantages of the present invention is that: because the elongated hole of the sleeve is provided with at least a first hole in any portion which has bigger aperture than other portions of the elongated hole, the aperture of the first hole is match to the periphery wall of the pin so that the pin can be inserted into the first hole; and the middle portion of the pin is provided with a groove, which is cooperated with the wall of the sleeve so that when the cover member is rotated, the two sides of the width direction of the elongated hole of the sleeve is clamped in the groove. The structure make that in the rotating of the cover member, the groove in the middle portion of the pin is maintaining clamping with the edges of width direction of the elongated hole, thus achieve the connecting between the toile cover member and the toilet body. In disassembly, it only needs to rotate the cover member to let the first hole of the sleeve of the cover member rotate to the position corresponding to the pin, then the cover member can be pull out from the pin, thus achieve the rapid assembly and disassembly of the cover member, and because the structure is simple, so it is easy-made and lower cost; because the top end of the pin is protruded out lip along fringe, and the top surface of the pin has a groove downwardly which can make the lip swing elastically, thus the lip of the pin can be clamped at the inner edge of the hole of the rotating shaft and will not be detached easily, so avoid the disadvantage that the cover member is shook in use.

Other objects, features and advantages of the present invention will become apparent from the subsequent description and the appended claims taken in conjunction with the accompanying drawings.

### BRIEF DESCRIPTION OF THE DRAWINGS

FIG. 1 is an exploded view of the present invention;

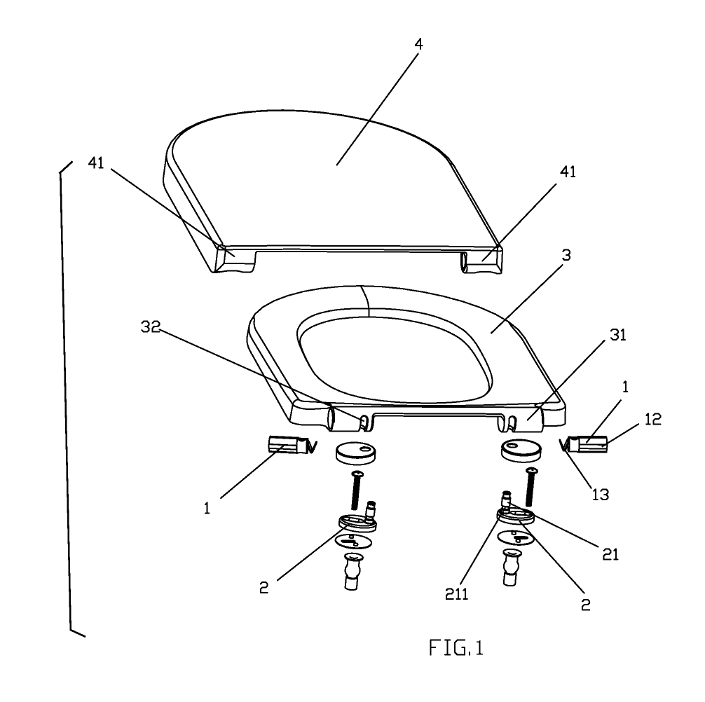

FIG. 2 is an exploded view of the present invention (the cover member is bottom-up);

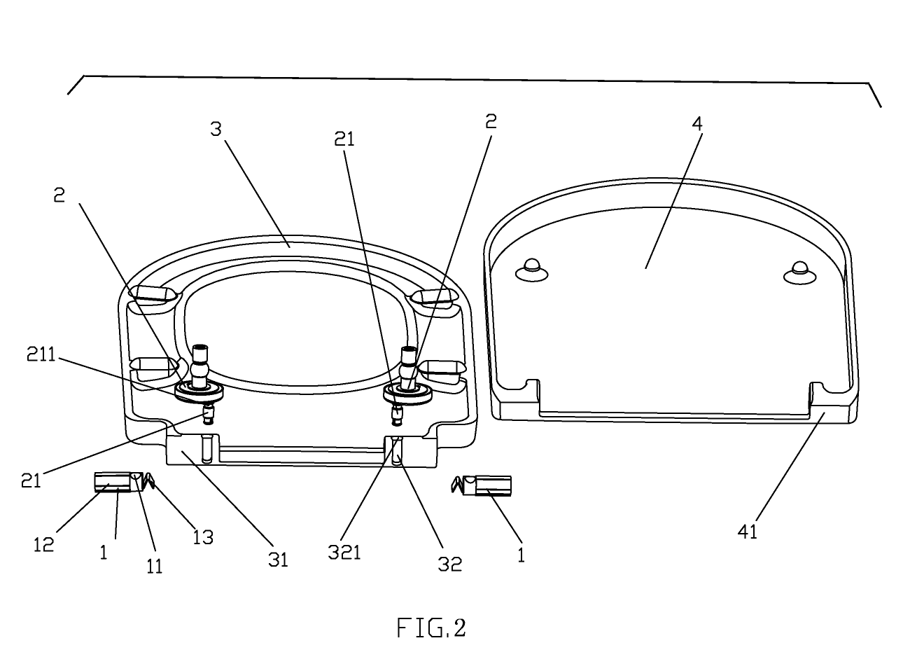

FIG. 3 is a perspective view of cover member (bottom-up) of the present invention;

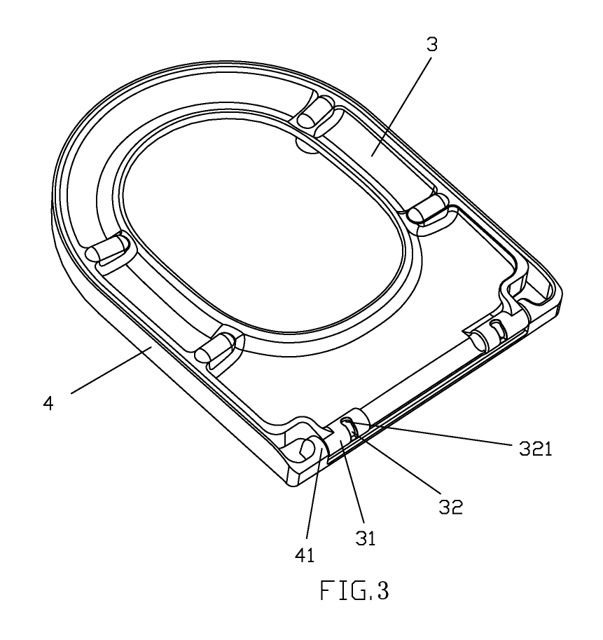

FIG. 4 is a sectional view of the present invention (cover member is put down on the body);

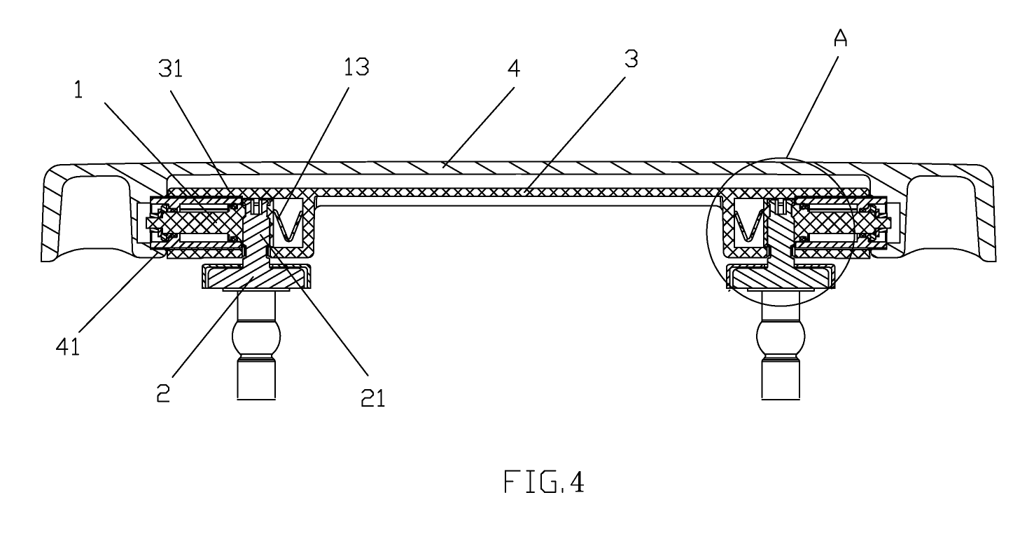

FIG. 5 is a partial enlarged view of the A portion of the FIG. 4;

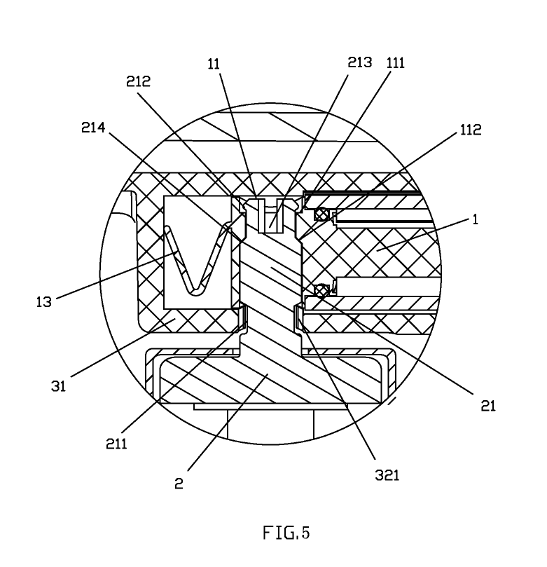

FIG. 6 is a sectional view of the present invention (cover member is lift up from the body);

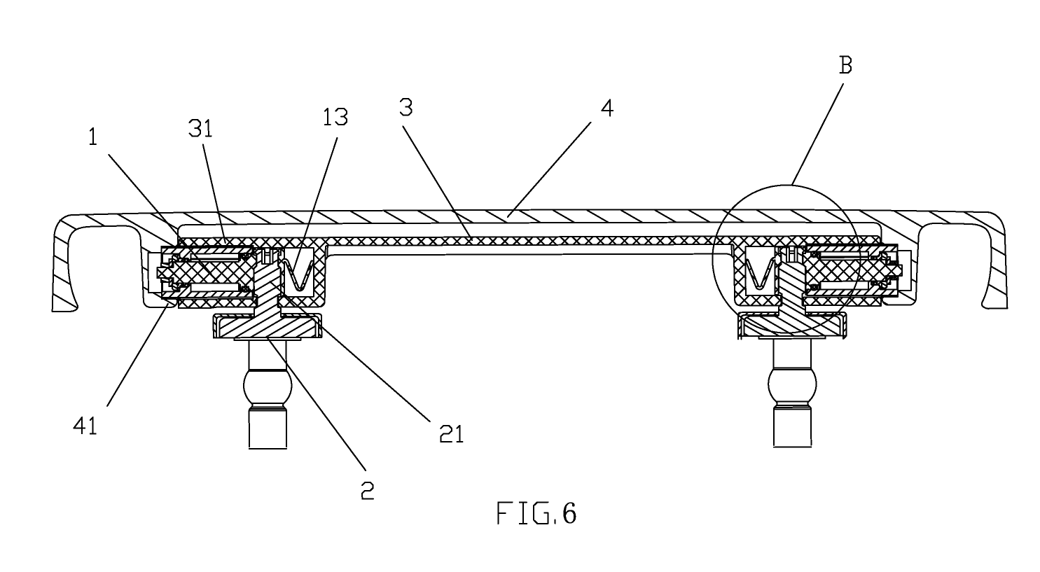

FIG. 7 is a partial enlarged view of the B portion of the FIG. 6;

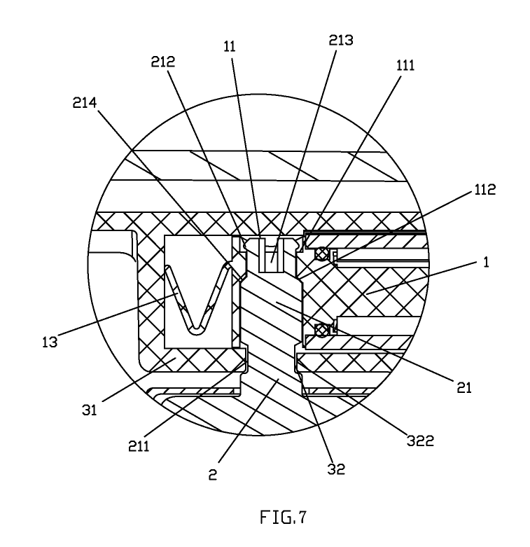

FIG. 8 is a sectional view of the present invention.

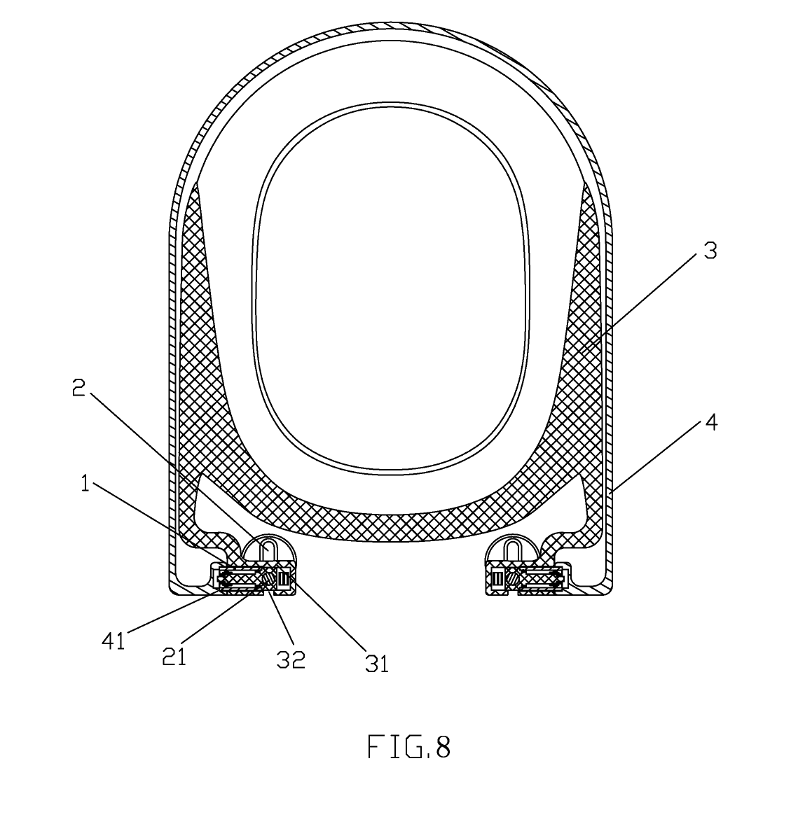

### DETAILED DESCRIPTION OF THE PREFERRED EMBODIMENT

Referring to the figures, the installation mechanism for the cover member of the present invention is used to install the cover member on the toilet body (not shown in the figures) so that the seat 3 and cover 4 of the cover member can be rotated relative to the body, for example, lift up or put down the cover 4 of the cover member, or lift up or put down the seat 3 of the cover member, or lift up or put down both of the cover seat 3 and cover 4.

Generally, the cover member needs two installation mechanisms, and the two installation mechanisms are symmetrical.

The installation mechanism for the cover member of the present invention which can be rapidly and conveniently assembled and disassembled comprises a rotating shaft 1 for the cover member rotating around, a support base 2 for fixing the rotating shaft 1 and a sleeve for containing the rotating shaft 1.

Because the cover member comprises a cover 4 and a seat 3, thus the sleeve can be divided into a first sleeve 31 and a second sleeve 41, the first sleeve 31 is integrated in the end of the seat 3, certainly, the first sleeve 31 also can be a separate unit fixed on the end of the seat 3. The second sleeve 41 is integrated in the end of the cover 4, certainly, the second sleeve 41 also can be a separate unit fixed on the end of the cover 4, in installation, the first sleeve 31 of the seat 3 must coaxially align with the second sleeve 41, so the front end of the cover member can be rotated relative to the rotating shaft 1.

The bottom of the support base 2 is fixed to the body (this is well known in the art), the top of the support base is provided with a pin 21 protruded upwardly; the first end of the rotating shaft 1 has a hole 11 along the radial direction for inserting the pin 21 of the support base, in this embodiment, the rotating shaft 1 is an rotating shaft integrated with a damp mechanism 12, certainly, it also can be a rotating shaft without damp mechanism, or the damp mechanism is a separate unit and is assembled to the rotating shaft.

The wall of the first sleeve 31 is provided with an elongated hole 32 along circumference for inserting and rotating the pin 21 of the support base; the rotating shaft 1 is assembled in the first sleeve 31 and the second sleeve 41, i.e. the rotating shaft 1 is inserted through the first sleeve 31 of the seat and the second sleeve 41 of the cover, the hole 11 of the rotating shaft is align with the elongated hole 32 of the first sleeve 31, and the pin 21 of the support base is inserted through the elongated hole 32 of the sleeve and then cooperated with the hole 11 of the rotating shaft.

One end of the elongated hole 32 of the sleeve 31 is set to be a first hole 321 which has bigger aperture than the other portion, the first hole 321 is in the position that the seat is cooperating with the pin 21 when covered on the body; certainly, the first hole 321 also can be in the end of the elongated hole in the position that the seat cooperating with the pin 21 when the seat is in totally opened relative to the body, or be the other positions; Certainly, the first hole can be multiple, for example, two holes, wherein one first hole disposed in the end of the elongated hole in the position in which the cover member is corresponding to the pin 21 when covered on the body; and the other first hole is in the end of the elongated hole in the position in which the cover member is corresponding to the pin 21 when the cover member is in totally opened position relative the body; The aperture of the first hole 321 is cooperated with the periphery wall of the pin 21 so that the pin 21 can be inserted into the first hole 321; the middle portion of the pin 21 has a groove 211 circle the periphery wall, certainly, it also can be the groove with other structure, e.g. only the position where the pin 21 contacting to the two sides 322 of width direction of the elongated hole 32 has groove; the groove 211 is cooperate with the periphery wall of the first sleeve 31 so that when the seat is rotated, the two sides of width direction of the elongated hole 32 of the first sleeve 31 is clamped in the groove 211.

Herein:

The upper portion of the pin has a lip extending outwardly from the edges, and the top surface of the pin 21 is provided with a slot 213 which can make the lip swing elastically; the hole 11 of the rotating shaft has an inner edge 111 which can clamp the lip of the upper portion of the pin; the pin 21 has a first step 214, and the hole 11 has a second step 112, the cooperation between the first step 214 of the pin 21 and the second step 112 of the hole 11 can let the pin 21 will not insert into the hole 11 too much, and this can prevent the seat 2 from being close to the cover member too much.

The first end of the rotating shaft 1 has an elastic structure 13 extended from the end; the elastic structure 13 is integrated with the rotating shaft 1; certainly, the elastic structure can also be a separated unit fixed on the first end of the rotating shaft.

In this embodiment, the elongated hole and the first hole are disposed in the first sleeve, i.e. in the seat; certainly, the elongated hole and the first hole also can be disposed in the second sleeve, i.e. in the cover, then the hole of the rotating shaft is disposed in the second sleeve accordingly.

The installation mechanism for the cover member of the present invention is to improve the elongated hole of the sleeve of the prior art, and the prior elongated hole which has same width and can containing the wall of the pin is improved to be a special elongated hole which has only one end can be inserted by the pin and the other portion can not be inserted by the pin, and the middle portion of the pin is disposed with a groove circle the circumference corresponding to the wall of the sleeve, and the groove can clamp the two sides in width of the elongated hole of the rotating shaft, if the cover member need to be installed onto the body, it only need to place the seat 3 horizontally, and aim the hole 11 of the rotating shaft to the first hole 321 of the elongated hole of the first sleeve 31, then insert the first hole 321 to the pin 21, the pin 21 will pass through the first hole 321 of the sleeve and insert into the hole 11 of the rotating shaft, thus the shaft is supported by the pin 21 when the seat 3 is lift up, the seat 3 rotated relative to the rotating shaft 1, and the first sleeve 31 of the seat 3 is also rotated relative to the rotating shaft 1, so the elongated hole 32 of the first sleeve 31 is moved relative to the hole 11 of the rotating shaft 31, because the pin 21 is inserted into the hole 11 of the rotating shaft, correspondingly, the elongated hole 32 of the sleeve is moved relative to the pin 21. If the elongated hole 32 is moved, the first hole 321 of the elongated hole will not be cooperated with the pin, but the pin 21 is cooperated with the other portion of the elongated hole except the hole 321, because the width of the other portion of the elongated hole except the hole 321 is narrow than the diameter of the pin 21, and the other portion is designed to be cooperated with the groove 211 of the pin, so when the pin 21 is moved relative to the elongated hole 32, the groove 211 of the pin is clamped in the edges 322 of the two sides of the width of the elongated hole, thus the pin 21 can not be pulled out from the elongated hole 32 of the first sleeve 31 until the cover member is in totally lift up status, accordingly, the cover member is connected to the body. When the cover member is to be detached from the body, it only need to put down the cover member, after being put down, the first hole 321 of the elongated hole of the first sleeve 31 of the seat 3 is align with the hole 11 of the rotating shaft, i.e. the pin 21 is inserted in the first hole 321 of the elongated hole of the first sleeve 31 of the seat 3, the first hole 321 is cooperated with the periphery wall of the pin 21, so raise the cover member will make the cover member detach from the pin 21, i.e. the cover member is detached from the body. In installation, firstly insert the end with elastic structure 13 of the rotating shaft into the first sleeve 31 of the seat, then push the second end of the rotating shaft 1 to push the rotating shaft 1 into the first sleeve 31, the elastic structure 13 is pressed by the rotating shaft 1 and the whole rotating shaft 1 is inserted into the first sleeve 31, then assemble the cover 4 with the seat 3, the first sleeve 31 and the second sleeve 41 is connected and aligned, the rotating shaft 1 is moved outwardly by the elastic force of the elastic structure 13, thus the second end of the rotating shaft 1 is inserted into the second sleeve 41, thus the rotating shaft 1 is connected to the first sleeve 31 and the second sleeve 41. This installation structure has not button system in prior art and the structure is very simple, thus the assembly and the disassembly is very convenient.

If the installation structure for the cover member of the present invention is provided with multiple first holes, each position the first hole aligned with the pin can assemble or disassemble the cover member.

The rapid assembly-disassembly method for the cover member of the present invention comprises:

The rear end of the cover member is provided with a pair of sleeves for containing the rotating shaft, each said sleeve is provided with an elongated hole for inserting and rotating the pin of the support base;

A pair of rotating shafts provided with corresponding hole for connecting to the support base;

A pair of support bases fixed on the body, each support base is provided with a pin which is inserted into the hole of the rotating shaft to connect the support base with the rotating shaft.

The elongated hole of the sleeve is provided with at least a first hole in any portion which has bigger aperture than other portion of the elongated hole, and the middle portion of said pin is provided with a groove, in assembly, the rotating shaft is installed to the cover member, and the hole of the rotating shaft is aimed to the first hole of the elongated hole of the sleeve, then the pin of the support base is insert into the rotating shaft through the first hole, thus the pin is connected to the rotating shaft, and the groove in the middle portion of the pin is positioned in the elongated hole of the sleeve, the pin is moved from the first hole and can not be pull out.

### INDUSTRIAL APPLICABILITY

The installation structure for the cover member of the present invention has simple structure and can be rapidly assembled and disassembled, thus has good industrial applicability

What is claimed is:

1/ An installation mechanism for toilet cover member comprising a rotating shaft for rotating the cover member, a support base for fixing the rotating shaft and a sleeve for containing the rotating shaft; said support base is provided with a pin for inserting into said rotating shaft, and said rotating shaft is provided with corresponding hole; said shaft is contained in said sleeve and said sleeve is provided with an elongated hole for inserting and rotating said pin of the support base;
the elongated hole of the sleeve is provided with at least a first hole in any portion which has bigger aperture than other portion of the elongated hole, the aperture of the first hole is matching with the peripheral wall of the pin so that the pin can be inserted into the first hole; the middle portion of said pin is provided with a groove, which is cooperated with the wall of the sleeve so that when the pin is moved from the first hole, the two sides of the width direction of the elongated hole of the sleeve is clamped in said groove.

2/ The installation mechanism for toilet cover member according to claim 1, wherein there is one first hole, and said first hole is disposed in the end of the elongated hole corresponding to the position in which the seat is cooperating with the pin when covered on the body.

3/ The installation mechanism for toilet cover member according to claim 1, wherein there is one first hole, and said first hole is disposed in the end of the elongated hole in the position that the seat cooperating with the pin 21 when the seat is in totally opened relative to the body.

4/ The installation mechanism for toilet cover member according to claim 1, wherein there are two first holes, one is disposed in the end of the elongated hole corresponding to the position in which the seat is cooperating with the pin 21 when covered on the body; and the other one is disposed in the end of the elongated hole in the position that the seat cooperating with the pin when the seat is in totally opened relative to the body.

5/ The installation mechanism for toilet cover member according to claim 1, wherein the upper portion of the pin has a lip extending outwardly from the edges, and the top surface of the pin is provided with a slot which can make the lip swing elastically; the hole of the rotating shaft has an inner edge which can clamp the lip of the upper portion of the pin.

6/ The installation mechanism for toilet cover member according to claim 1, wherein the first end of the rotating shaft has an elastic structure extended from the end.

7/ The installation mechanism for toilet cover member according to claim 6, wherein the elastic structure is integrated with the rotating shaft; or the elastic structure is a separated unit fixed on the first end of the rotating shaft.

8/ The installation mechanism for toilet cover member according to claim 1, wherein the rotating shaft is an rotating shaft integrated with a damp mechanism, the first end of the rotating shaft is provided with a hole in radial direction for inserting the pin of the support base, and the second end of the rotating shaft is provided with a damp mechanism, said damp mechanism is cooperated with the sleeve of the cover member.

9/ The installation mechanism for toilet cover member according to claim 1, wherein said cover member comprises a cover and a seat, said seat is provided with a first sleeve, and said cover is provided with a second sleeve coaxially cooperated with said seat, said rotating shaft is inserted through the first sleeve of the seat and the second sleeve of the cover, said elongated hole and said first hole are disposed in the first sleeve.

10. A rapid assembly-disassembly method for the cover member of the present invention comprises:
the rear end of the cover member is provided with a pair of sleeves for containing the rotating shaft, each said sleeve is provided with an elongated hole for inserting and rotating the pin of the support base;
a pair of rotating shafts provided with corresponding hole for connecting to the support base;
a pair of support bases fixed on the body, each support base is provided with a pin which is inserted into the hole of the rotating shaft to connect the support base with the rotating shaft;
the elongated hole of the sleeve is provided with at least a first hole in any portion which has bigger aperture than other portion of the elongated hole, and the middle portion of said pin is provided with a groove, in assembly, the rotating shaft is installed to the cover member, and the hole of the rotating shaft is aimed to the first hole of the elongated hole of the sleeve, then the pin of the support base is insert into the rotating shaft through the first hole, thus the pin is connected to the rotating shaft, and the groove in the middle portion of the pin is positioned in the elongated hole of the sleeve, the pin is moved from the first hole and can not be pull out.
